(19) United States
(12) Patent Application Publication
(10) Pub. No.: US 2014/0153272 A1
(43) Pub. Date: Jun. 5, 2014

(54) LIGHTING AND/OR SIGNALING DEVICE, NOTABLY FOR A MOTOR VEHICLE

(71) Applicant: Valeo Vision, Bobigny Cedex (FR)

(72) Inventors: Sylvain Giraud, La Fleche (FR); Jean-Francois Doha, Saint Barthelemy d'Anjou (FR); Arnaud Perrotin, Angers (FR)

(21) Appl. No.: 14/091,968

(22) Filed: Nov. 27, 2013

(30) Foreign Application Priority Data
Nov. 30, 2012 (FR) 1261511

(51) Int. Cl. F21S 8/10

(52) U.S. Cl. CPC F21S 48/1241; F21S 48/2231
USPC 362/511

(57) ABSTRACT

A lighting and/or signaling device, notably for a motor vehicle, comprising at least one light source and one light guide, the source comprising a support and a plurality of light emitting components arranged on the support so as to emit a beam of light, the device being configured to direct the beam toward the guide, in which device the support is a printed circuit and/or the light emitting components are light emitting diodes, in which device the light emitting components are arranged in such a way as to define an emission surface for the beam of light on a face of the support, in which device the light source is configured so that the emission surface has a longitudinally extending axis, in which device the light guide comprises at least one emitting portion configured to emit light out of the guide, and at least one guide portion, situated between the source and the emitting portion, configured to transmit the beam of light from the source to the emitting portion.

In one embodiment, the guide portion has a cross section that is smaller than that of the emitting portion.

### CROSS-REFERENCE TO RELATED APPLICATIONS

This application claims priority to French Application No. 1261511 filed Nov. 30, 2012.

### BACKGROUND OF THE INVENTION

1. Field of the Invention

The present invention relates to a lighting and/or signaling device, notably for a motor vehicle. It is intended in particular for signaling lights and/or daytime running lights, although it is not in any way restricted to such applications.

2. Description of the Related Art

In this field, it is known that manufacturers wish to add distinctive features, notably using visibly original elements, so that they more readily stand out from the competition.

Thus, devices equipped with a light source, generally a light emitting diode, and a light guide in the form of a string or a layer from which light is emitted in a free geometric pattern, are known. The light travels along the guide by total internal reflection until it reaches an outlet face, which projects the light in such a way that it can be seen by the vehicles behind or in front. In the automotive field, such devices are well-received because they are able to offer a wide variety of shapes and types of light.

These devices nowadays use light sources comprising a support used to supply electrical current to a single light emitting diode, referred to as a single-point light source. The sources have limited light intensity.

That being the case, their emission surface area is small, measuring around 1 mm in diameter. In the case of light guides with a surface configuration, the inlet surface for the light is along an edge face of the guide, of similar thickness. It is therefore conceivable to incorporate a plurality of single-point light sources along the inlet face thus making it possible to obtain good light intensity.

In the case of a guide in the form of a string having a cross section the desired diameter of which is around ten millimeters or so, increasing the number of single-point light sources in order to achieve the desired level of brightness has its limits. Specifically, it is a complex matter to couple a great many sources to the guide, and the brightness losses generated as a result of coupling difficulties also limit the benefit of such a solution.

### SUMMARY OF THE INVENTION

The invention therefore seeks to obtain a device, equipped with a light guide, particularly in the form of a string, that is capable of achieving the brightness criteria set by the regulations while at the same time limiting the number of light sources.

To do that, the lighting and/or signaling device, notably for a motor vehicle, according to the invention, comprises at least one light source and one light guide, the source comprising a support and a plurality of light emitting components arranged on the support so as to emit a beam of light, the device being configured to direct the beam toward the guide, in which device the support is a printed circuit and/or the light emitting components are light emitting diodes, in which device the light emitting components are arranged in such a way as to define an emission surface for the beam of light on a face of the support, in which device the light source is configured so that the emission surface has a longitudinally extending axis, in which device the light guide comprises at least one emitting portion configured to emit light out of the guide, and at least one guide portion, situated between the source and the emitting portion, configured to transmit the beam of light from the source to the emitting portion, wherein the guide portion has a cross section that is smaller than that of the emitting portion.

By using such light sources, also referred to as multi-point sources, the light emitters are incorporated into the source and a beam of light is available that has a higher intensity of brightness while at the same time the difficulties of incorporating the light sources into the device are limited. Specifically, for a given intensity of light emitted by the device, the sources are less numerous than is the case if using single-point sources. In other words, such a solution makes it easier for the light sources and the guide to be coupled together.

According to various embodiments of the invention, which may be considered together or separately:
transverse axis of elongation of the guide portions is oriented along the longitudinal axis of the emission surface of the light sources;
the cross section of the guide portions is rectangular and/or oval;
the device comprises several the light sources;
the light guide comprises several guide portions, situated between each of the sources and the emitting portion;
each guide portion comprises an interface zone forming an interface with the emitting portion, the interface zones being distinct from one another;
the interface zones between each of the guide portions and the emitting portion are contiguous zones;
as an alternative, the guide portions comprise an interface zone that is common with the emitting portion;
the guide then comprises an interface zone forming an interface between the guide portions, this notably being defined by a plane;
the interface zones are situated at an inlet face of the emitting portion;
the interface zones are centered on the inlet face of the emitting portion;
the guide portions may or may not converge toward a single point on the inlet surface;
the surface area of the interface zone and/or the sum of the surface areas of the interface zones is smaller than the cross section of the emitting portion.

The invention also relates to a lighting and/or signaling housing comprising the device.

These and other objects and advantages of the invention will be apparent from the following description, the accompanying drawings and the appended claims.

### BRIEF DESCRIPTION OF THE ACCOMPANYING DRAWINGS

The invention will be better understood in the light of the following description which is given purely by way of nonlimiting indication, and which is accompanied by the attached drawings in which:

FIG. 1 illustrates a perspective view of a lighting or signaling device according to a first embodiment of the invention, the light guide of the device being illustrated over just part of its length;

FIG. 2 illustrates a perspective view of a lighting or signaling device according to a second embodiment of the invention, the light guide of the device being illustrated over just part of its length;

FIG. 3 is a view of FIG. 2 from above;

FIG. 4 illustrates a perspective view of a lighting or signaling device according to a third embodiment of the invention, the light guide of the device being illustrated over just part of its length;

FIG. 5 is a view of FIG. 4 from above;

FIG. 6 illustrates a perspective view of a lighting or signaling device according to a fourth embodiment of the invention, the light guide of the device being illustrated over just part of its length;

FIG. 7 is a view of FIG. 6 from above; and

FIG. 8 schematically illustrates one example of a light source of a lighting and/or signaling device according to the invention.

### DETAILED DESCRIPTION OF THE PREFERRED EMBODIMENTS

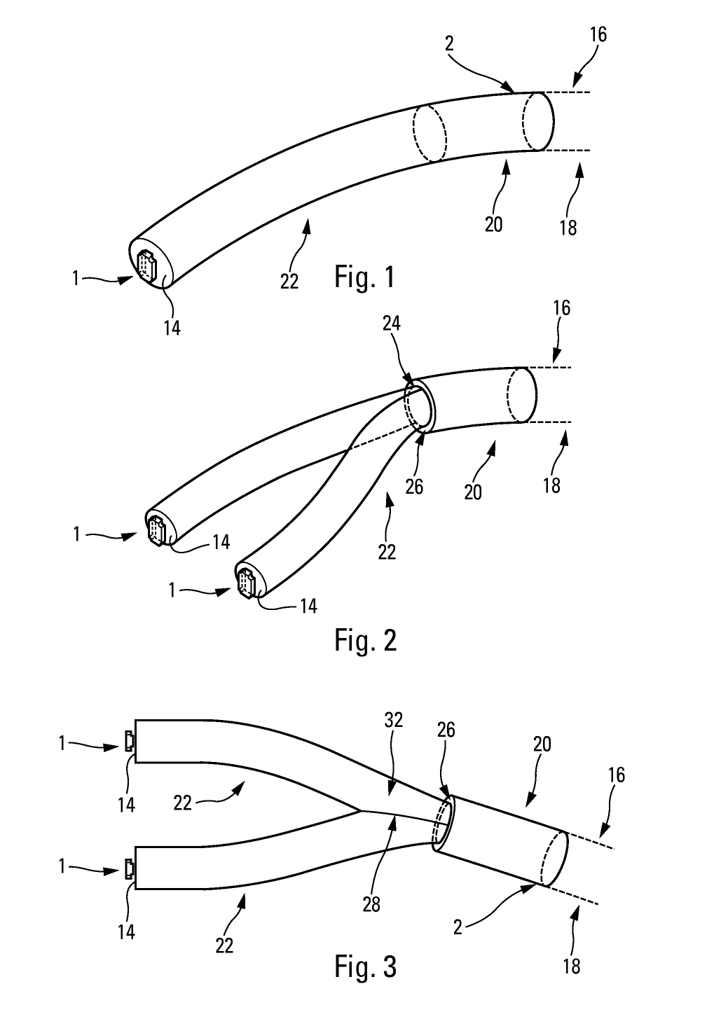

As illustrated in FIGS. 1 to 7, the invention relates to a lighting and/or signaling device. The device will find applications as side light and/or signaling light and/or daytime running light, although this cannot be considered to be limiting.

The device comprises at least one light source 1 and a light guide 2.

As is more visible in FIG. 8, the light source 1 comprises a support 4 and a plurality of light emitting components 6, in this instance four, illustrated schematically in dotted line. The components 6 are arranged on the support 4 in such a way as to emit a beam of light. Such a light source 1 is also referred to as a multi-point light source, as opposed to sources, referred to as single-point sources, that comprise just one emitter of light. They have the advantage of offering a higher power of light with greater ease of integration. In particular, the components 6 of one and the same light source 1 share the same support 4.

The support 4 is, for example, a printed circuit. It is used notably for attaching the light emitting components 6 and/or for supplying them with electrical current. It may be a support of SMI type or an insulated metal substrate. Optionally, the support 4 further comprises components for controlling the strength of current supplied to the light emitting components 6.

The light emitting components 6 are, for example, light emitting diodes. They advantageously emit a white light, because white diodes are currently the most powerful.

The light emitting components 6, in this instance the light emitting diodes, are arranged in such a way as to define an emission surface 10 for the beam of light on one face 12 of the support 4. In other words, the light emitting components are arranged on one and the same side of the support 4, in a dedicated zone thereof. That being the case, the beam emitted by the emission surface 10 has a light intensity which is not necessarily completely homogeneous. In particular, the emission surface may have zones that light up better than others. The light emitting components 6 are, however, packed closely enough within the emission surface 10 to avoid giving the impression of there being any unlit zones between them. The light source 2 may be configured in such a way that the emission surface 10 has a longitudinal axis of extension. In other words, the emission surface 10 has a favored direction of elongation. Put differently again, the emission surface is neither square nor circular. In this instance it is substantially rectangular.

If reference is made once again to FIGS. 1 to 7, it may be seen that the device is configured to direct the beam toward the guide 2. The light sources 1 are here arranged facing one or more inlet faces 14 of the light guide 2 so that the beam of light emitted by the or each of the light sources 1 enters the light guide 2 via the inlet faces 14 of the guide 2.

The light guide 2 is configured to guide the light that enters via the inlet faces 14 as far as an outlet face 16 of the guide 2, notably using total internal reflection. In the known way, the guide 2 comprises a reflection face 18, equipped with optical patterns which have not been illustrated that allow some of the rays of light traveling along the guide 2 to emerge therefrom via the outlet face 16, provided opposite the reflection face 18.

The light guide 2 in this instance is a linear guide, of straight or curved longitudinal shape, depending on the usage requirements for the device 1. In other words, the guide 2 takes the form of a string or longilinear element, i.e. an element which has a cross section the dimensions of which are very much smaller than its length. Devices equipped with such guides 2 are particularly advantageous because they can be laid out in numerous ways, in a minimum amount of space. It is thus possible to give the guides 2 original shapes and allow esthetic creations of innovative design.

The light guide 2 here comprises at least one emitting portion 20 configured to emit light out of the guide 2, and at least one guide portion 22, situated between the source 1 and the emitting portion 20, and configured to transmit the beam of light from the source 1 to the emitting portion 20. In other words, the inlet faces 12 of the guide 2 are at the guide portions 22, whereas the reflection faces 18 and outlet faces 16 are at the emitting portion 20. The emitting portion 20 has, for example, a circular and/or constant cross section, if the optical patterns created are disregarded.

According to the embodiment of FIG. 1, the device comprises one single the light source 1 and the guide 2 comprises one single the guide portion 22. The emitting portion 20 here lies in the continuation of the guide portion 22. The guide portion 22 and the emitting portion 20 thus have the same, for example circular, cross section.

According to the other embodiments illustrated, the device comprises several the light sources 1 and the light guide 2 comprises several guide portions 22 which are situated between each of the sources 1 and the emitting portion 20. Here, two light sources 1 and two guide portions 22, respectively associated with one another, are provided.

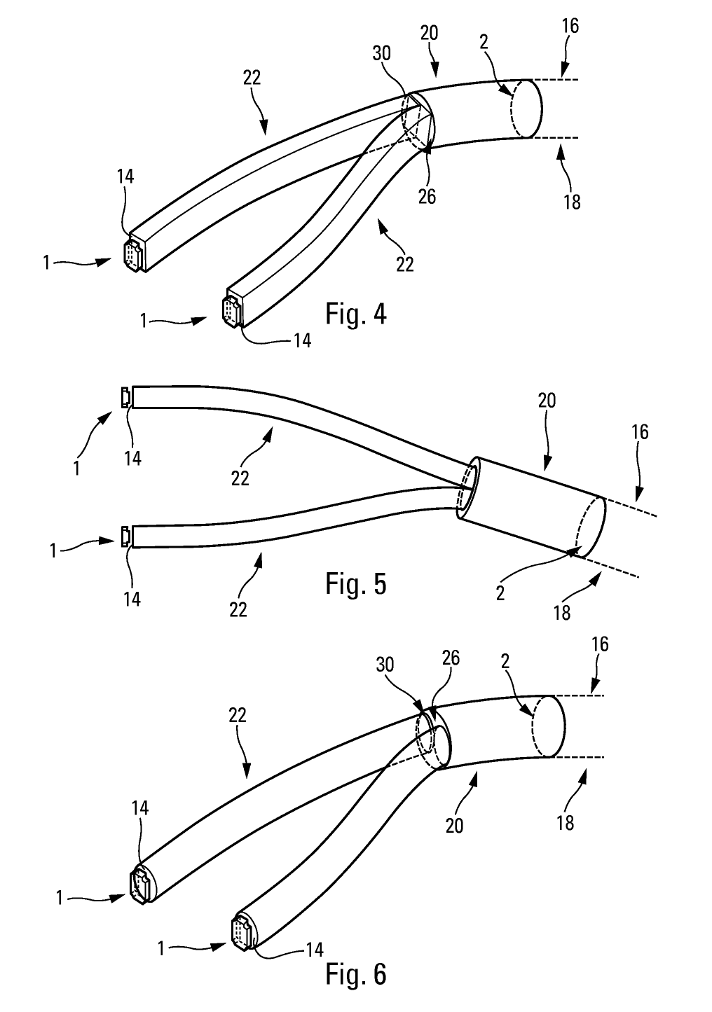

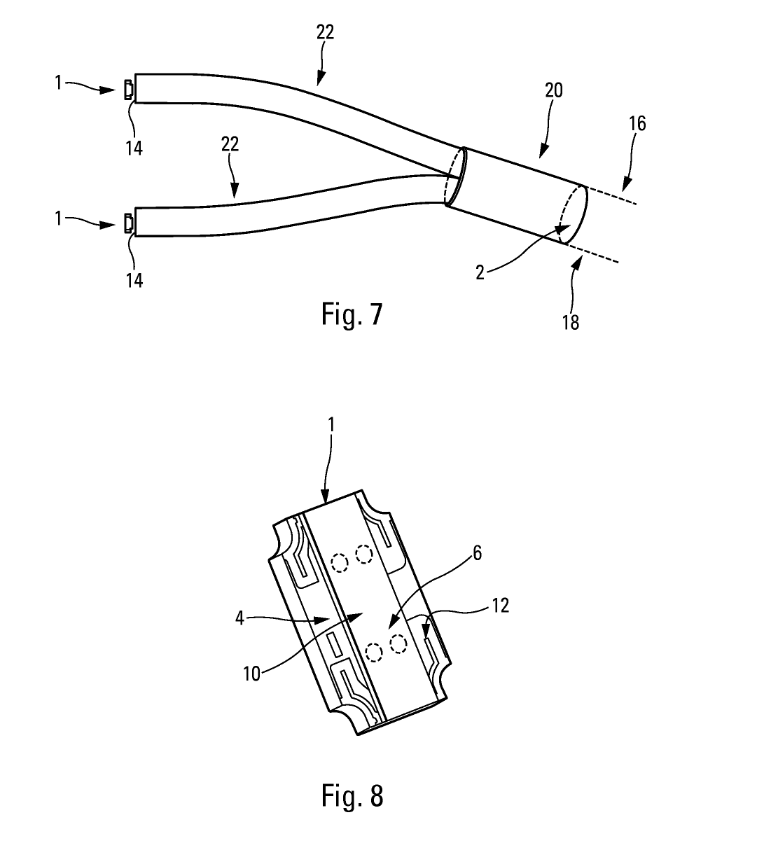

The guide portions 22 advantageously have a transverse axis of elongation oriented along the longitudinal axis of the emission surface 10 of the light sources 1. In other words, the guide portions 22 are likewise elongate in a given direction and their direction of elongation is made to correspond to that of the corresponding light sources 1 emission surface. To this end, the cross section of the guide portions 22 is, for example, rectangular, as in FIGS. 4 and 5, and/or oval, as in FIGS. 6 and 7.

If reference is made to FIGS. 2 and 3, it may be seen that, in a first variant, the guide portions 22 comprise an interface zone 24 common with the emitting portion 20, in particular situated at an inlet face 26 of the emitting portion 20.

In this variant, the guide 2 comprises an interface zone 24 forming an interface between the guide portions 22, and defined by a plane. In other words, the guide 2 has a zone of convergence situated upstream of the emitting portion 20. The plane 28 is, for example, perpendicular to the inlet face 26 of the emitting portion 22. The guide portions are advantageously symmetric on either side of the plane in the convergence zone. The guide portions 22 are here, for example, of circular and/or constant cross section, before the convergence zone. The coupling portion 32 formed by the union of the guide portions 22 in the convergence zone may also be of constant cross section as far as the inlet face 26 of the emitting portion 20, i.e., may be of a cross section similar to the profile of the interface zone 28.

The latter may have a shape that exhibits symmetry with respect to an axis of symmetry of the inlet face 26 of the emitting portion 20, notably one of the diameters thereof.

In a first configuration, the guide portions 22 converge to a single point at the surface of the inlet face 26 of the emitting portion 20, notably the center thereof. In another configuration, they converge to two distinct points on the inlet face 26 of the emitting portion 20, for example points approximately 2 mm apart.

As an alternative, according to the embodiments of FIGS. 4 to 7, each guide portion 22 comprises an interface zone 30 forming an interface with the emitting portion 20, particularly the inlet face 26 thereof. The interface zones 30 are distinct from one another here, for example contiguous. That approach promotes a reduction in optical losses.

The interface zones 30 could be symmetric with respect to one another about an axis of symmetry of the inlet face 26 of the emitting portion 20, notably one of the diameters thereof.

In other words, in these various embodiments, the interface zones 24, 30 can be considered to be centered on the inlet face 26 of the emitting portion 2. Such a feature likewise contributes to reducing optical losses.

Advantageously, each of the guide portions 22 will have a cross section that is smaller than that of the emitting portion 20. More specifically, in this case, the surface area of the interface zone 24, in the embodiment of FIGS. 2 and 3, is smaller than the cross section of the emitting portion. In other words, the cross section of the coupling portion 32 is smaller than the cross section of the emitting zone 20.

In the embodiments of FIGS. 4 to 6, it is the sum of the surface areas of the interface zones 30 which is less than the cross section of the emitting portion 20.

The invention also relates to a lighting and/or signaling housing comprising one or more devices as described above. The housing may comprise other types of lighting and/or signaling devices so as to combine a number of optical functions.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and/or signaling device, notably for a motor vehicle, comprising at least one light source and one light guide, said at least one light source comprising a support and a plurality of light emitting components arranged on said support so as to emit a beam of light, said device being configured to direct said beam toward said light guide, in which device said support is a printed circuit and/or said light emitting components are light emitting diodes, in which device said light emitting components are arranged in such a way as to define an emission surface for said beam of light on a face of said support, in which device said at least one light source is configured so that said emission surface has a longitudinally extending axis, in which device said light guide comprises at least one emitting portion configured to emit light out of said light guide, and at least one guide portion, situated between said at least one light source and said at least one light emitting portion, configured to transmit said beam of light from said at least one light source to said at least one emitting portion,
wherein said at least one light guide portion has a cross section that is smaller than that of said at least one emitting portion.

2. The lighting and/or signaling device according to Claim 1, in which a transverse axis of elongation of said at least one guide portion is oriented along the longitudinal axis of said emission surface of said at least one light source.

3. The lighting and/or signaling device according to claim 1, in which the cross section of said at least one guide portion is rectangular and/or oval.

4. The lighting and/or signaling device according to claim 1, in which said device comprises several of said at least one light sources.

5. The lighting and/or signaling device according to claim 4, in which said light guide comprises several of said at least one guide portions, situated between each of said at least one light sources and said at least one emitting portion.

6. The lighting and/or signaling device according to claim 5, in which each of said at least one guide portion comprises an interface zone forming an interface with said at least one emitting portion, said interface zones being distinct from one another.

7. The lighting and/or signaling device according to claim 5, in which said at least one guide portions comprise an interface zone that is common with said at least emitting portion.

8. The lighting and/or signaling device according to claim 6, in which said interface zones are situated at an inlet face of said at least one emitting portion.

9. The lighting and/or signaling device according to claim 8, in which said interface zones are centered on said inlet face of said at least one emitting portion.

10. The lighting and/or signaling device according to claim 7, in which a surface area of said interface zone and/or the sum of surface areas of said interface zones is smaller than the cross section of the said at least one emitting portion.

11. A lighting and/or signaling housing comprising a device according to claim 1.

12. The lighting and/or signaling device according to claim 2, in which the cross section of said at least one guide portions is rectangular and/or oval.

13. The lighting and/or signaling device according to claim 2, in which said device comprises several said at least one light sources.

14. The lighting and/or signaling device according to claim 3, in which said device comprises several said at least one light sources.

15. The lighting and/or signaling device according to claim 7, in which said interface zones are situated at an inlet face of said at least one emitting portion.

16. The lighting and/or signaling device according to claim 8, in which a surface area of said interface zone and/or the sum of surface areas of said interface zones is smaller than the cross section of said at least one emitting portion.

17. The lighting and/or signaling device according to claim 9, in which a surface area of said interface zone and/or the sum of surface areas of said interface zones is smaller than the cross section of said at least one emitting portion.

18. A lighting and/or signaling housing comprising a device according to claim 2.

19. A lighting and/or signaling housing comprising a device according to claim 3.

20. A lighting and/or signaling housing comprising a device according to claim 4.
